(19) United States
(12) Patent Application Publication
(10) Pub. No.: US 2005/0257834 A1
(43) Pub. Date: Nov. 24, 2005

(54) Freeze-free air hose coupling

(76) Inventor: Oriz Wickline Johnson, Cincinnati, OH (US)

Correspondence Address: ORIZ W. JOHNSON, 7086 BUTTERWOOD DRIVE, CINCINNATI, OH, 45241, US

(21) Appl. No.: 10/848,864

(22) Filed: May 20, 2004

(51) Int. Cl. F16L 58/04

(52) U.S. Cl. 137/375

(57) ABSTRACT

An improved air hose coupling for cold weather operation for use on outdoor tire inflator machines said coupling having an internal water trap, airway check valve, thermal insulated airways, and multiple air inlets to preclude water condensate from freezing inside the cold metal of the coupling or connected tire filling nozzle during cold weather.

### CROSS REFERENCES TO RELATED APPLICATIONS

None

### FEDERALLY SPONSORED RESEARCH

None

### MICROFICE APPENDIX

None

### BACKGROUND OF THE INVENTION

1. Field of the Invention

Class 285/238/239/242

2. Discussion of the Prior Art

Of the literally millions of air hoses in use today, the overwhelming majority are employed indoors and are not germane to this discussion except to state that these indoor hoses are generally for air tools in a system having a compressed air tank complete with gravity water collection and drain cocks to blow water out of the system, sophisticated air-driers, oilers and other accoutrements to protect and assist the air tools. Being indoors and free of water, no need exists nor thought given to freeze protected couplings. Moreover an examination of prior art in coupling patents per se, finds much focus on insuring the coupling stays coupled but no focus on freezing.

Indoor systems notwithstanding, there are more than a hundred thousand minimalist automobile tire inflator machine systems located outdoors, primarily at service stations and convenience stores, and used by customers year round, night or day, summer or winter, in the order of one billion times per year. It is that during winter and intermediate seasons when the outdoor temperature drops below freezing, water vapor introduced in the compression process will condense inside the hose and gravitate to the end of the hose assembly there to freeze and block the tiny airways of the metal hose coupling or attached tire filling nozzle. This condensate water travels within the system in two forms, liquid driven by gravity and vapor by vapor pressure which seeks the coldest component of a closed system. The two forms must thusly be separately addressed.

### OBJECTIVE AND ADVANTAGES OF THE INVENTION

This perennial frozen condensate phenomenon has plagued the tire inflator machine industry without relief from any known device, technology, or technique, since the industry's inception some 20 years ago. Tiny balls of ice smaller than BB's cause countless customer complaints, countless dollars of expense and countless wasted hours of time servicing this evanescent but inescapable phenomenon. The improved freeze-free coupling simple as it is, may well eliminate more than half of all winter and transition-season service problems.

### SUMMARY OF THE INVENTION

While the certainty of both water vapor and water condensation inside the compressed air tire inflator system is by definition inescapable, the control of the actual water flow is possible, as is insulating it against freezing. The water is isolated from cold metal surfaces first by trapping the condensate in a safe retaining reservoir within the hose. As previously cited, a ball of ice smaller than a BB can totally block the air system. While the compressed air within the hose generally has less than five BB's of potential water, the reservoir as proposed has over-kill room for fifty BB's. Secondly, by insulating the internal airway of the coupling with a non-metallic tube liner insures that if water does enter the cold coupling, it is less likely to freeze.

Water vapor unlike water per se, is immune to this reservoir trap and will migrate inexorably through the hose, floating airborne through the reservoir, through the coupling, to the cold mass of the filling nozzle. This migration is countered in two steps, first, by the aforementioned insulating tube liner in the coupling airway and secondly, by sealing the insulating tube itself against vapor migration with a spring-biased stop-valve. The stop-valve is forced open by compressed air when the system is in operation allowing air to flow.

There are four additional features of the coupling, the first of which is when the hose has been hung up on its off-duty hook or lying on the ground on an angle, water can drain down into the coupling, a permanent sloping-top cap in the forward end of the insulating tube directs water oozing down the hose and dripping onto it onto the sides of the water reservoir where it collects. Secondly, the insulation tube extension creates a water level weir as it were, inasmuch as the location of multiple air inlet holes set the level of fullness the draining water must reach to enter the tube. If not much water is in the hose, it's all trapped in the hose outside the tube and no harm done. Thirdly, a thin-wall sleeve inserted as a metal extension onto the end of the insertion barb and into the water reservoir serves as a metal-wall heat sink to absorb and conduct residual heat from collected water to the mass of the metal coupling, prompting the water to freeze there in the sink instead of causing mischief inside the coupling. And lastly, not one, but at least four air inlet holes in the insulating tube extension preclude the system being shut down by ice blocking any single inlet hole.

### DESCRIPTION OF THE DRAWINGS

FIG. 1: A cutaway elevation view of the coupling installed on a conventional air hose showing the reamed ID section, airway liner tube, spring biased stop-valve, in-line heat sink and multiple air inlets.

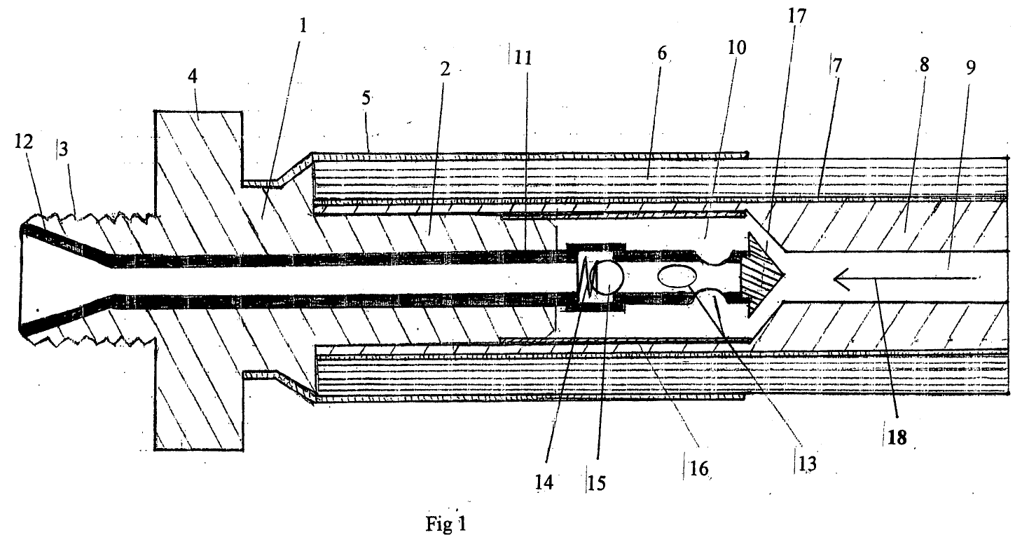

### LIST OF REFERENCE NUMBERS IN THE DRAWING

Coupling body 1
Insertion barb 2
Threaded end 3
Wrench lands 4
Compression sleeve 5
Hose outer membrane 6
Steel braid 7
Hose inner membrane 8
Hose airway 9
Water reservoir cavity 10
Insulating liner tube 11
Tube flared end 12
Transverse air holes 13
Stopper 14
Stopper spring 15
Thin-wall heat sink 16
Sloping cap 17
Air flow direction 18

### DESCRIPTION OF THE INVENTION

Coupling body 1, insertion barb 2, threaded end 3, wrench lands 4 and compression sleeve 5 are components of both the invention and a standard off-the-shelf hose coupling deviating only in that the OD and ID of the proposed hose insertion barb 2 are significantly larger, and the compression sleeve 5, normally ending at the end of the insertion barb, is longer to protect the thin-wall water reservoir cavity 10. By like measure, outside rubber membrane 6, steel braid 7, interior rubber membrane 8 and airway 9 are identical to that of most popular off-the-shelf braided hoses, except that the ID of the hose has been precisely reamed larger to accommodate the aforementioned larger insertion barb OD 2, and secondly, to insure that a thin layer of the interior rubber membrane 8 remains to protect the steel braid against condensate water and internal rusting. The hose airway is reamed further to a certain depth to create a cavity 10 beyond the end of the insertion barb. It is possible to employ an air hose having a larger ID negating the need to ream out the end, but the larger hose is more expensive, heavier and harder for the customer to use. Reaming out a ¼″ hose as discussed above is not difficult and is the preferred technique. Before inserting the coupling insertion barb into the reamed hose, a non-metallic thin-wall plastic tube 11 is slipped snuggly into the coupling airway as an insulating liner. The liner tube flared 12 at its exterior end, extends thru the coupling and into the water reservoir cavity 10. The tube has four transverse air inlet holes 13 through its wall near its forward end, each of the four holes having approximately the same area as the single airway of an off-the-shelf insertion barb. The forward end of the tube, beyond the transverse holes, is fitted with a sloping-roof cap 17. A thin-wall metal tube 16 affixed snuggly on the insertion barb serves as a heat sink extension into the reservoir cavity 10. Lastly a vapor-stopper ball 14 and positioning spring 15 is seated within the tube.

### RAMIFICATIONS AND SCOPE OF THE INVENTION

While the above descriptions of my preferred embodiment contains many specificities, these should not be construed as limitation on the scope of the invention, but rather as an exemplification of one preferred embodiment thereof. Many other variations of virtually every concept or component defined are possible, accordingly the scope of the invention should be determined not by the embodiment illustrated but by the appended claims and their legal equivalents

1. An improved air hose coupling 1 for cold environment operation, wherein the coupling has an enlarged airway and an airway thermal insulation liner, said liner comprising a non-metallic tube 11 fixedly inserted forward from standard threaded-end 3 of said coupling through the length of the enlarged coupling airway and extending beyond the end of the coupling barb for a predetermined distance.

2. An improved air hose coupling for cold environment operation as recited in claim 1, wherein said liner tube has a plurality of transverse air inlet holes 13 near end of tube,
whereby no condensate water may enter the coupling airway unless carried by compressed air flow or unless the level of water collected around the base of the extended liner tube has reached the level of the nearest transverse air inlet.

3. An improved air hose coupling for cold environment operation as recited in claim 1, wherein said liner tube extension has an internal spring-biased air flow stop-valve 14,
whereby any water vapor migration or liquid water flow from the flexible air hose is prohibited from entering the coupling airway further unless the compressed air source is operating.

4. An improved air hose coupling for cold environment operation as recited in claim 1, wherein said coupling barb has a thin-wall metal tube 16 sleeve of predetermined cross section and length fixedly attached in line to the end of the coupling barb 2,
whereby this tube sleeve extension acts as a heat sink inducing such water as will, to freeze on the cold surface and be captured by the sink.

5. A method for protecting outdoor tire inflator machine air hose couplings against internal ice blockage during cold weather comprising:
(a) flow controlling means for directing hose-condensate water flow away from said coupling airway,
(b) providing an insulation barrier between cold metal surface of said coupling airway and intruding condensate water,
(c) freezing means for extracting heat from extant cold condensate water in safe areas away from said coupling,
(d) stopping means for positive stopping water/vapor migration before entering said coupling airway,
(e) providing multiple air inlets to said coupling airway.
